(19) United States
(12) Patent Application Publication
(10) Pub. No.: US 2005/0104505 A1
(43) Pub. Date: May 19, 2005

(54) Image display apparatus and method of manufacturing the same

(76) Inventors: Shigeo Takenaka, Fukaya-shi (JP); Masaru Nikaido, Yokosuka-shi (JP); Satoko Oyaizu, Fukaya-shi (JP); Satoshi Ishikawa, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/954,070

(22) Filed: Sep. 30, 2004

Related U.S. Application Data
(63) Continuation of application No. PCT/JP03/04109, filed on Mar. 31, 2003.

(30) Foreign Application Priority Data
Apr. 3, 2002 (JP) 2002-101575

(51) Int. Cl. H01J 1/62

(52) U.S. Cl. 313/495

(57) ABSTRACT

An image display apparatus includes a first substrate having an image display surface, and a second substrate which faces the first substrate with a gap and has a plurality of electron sources configured to exciting the image display surface. A plurality of spacers which resist an atmospheric pressure acting on the substrates are arranged between the first and second substrates. Conductors which repulse electron beams emitted from the electron sources are interposed between the second substrate and distal ends of the spacers on the second substrate side.

### CROSS REFERENCE TO RELATED APPLICATIONS

This is a Continuation Application of PCT Application No. PCT/JP03/04109, filed Mar. 31, 2003, which was published under PCT Article 21(2) in Japanese.

This application is based upon and claims the benefit of priority from prior Japanese Patent Application No. 2002-101575, filed Apr. 3, 2002, the entire contents of which are incorporated herein by reference.

### BACKGROUND OF THE INVENTION

1. Field of the Invention

The present invention relates to an image display apparatus equipped with substrates opposing each other and a plurality of electron sources provided on the inner surface of one of the substrates, and a method of manufacturing the same.

2. Description of the Related Art

Image display apparatuses for high-definition broadcasting or similar high-resolution display apparatuses are now being demanded. Concerning their screen display performance, in particular, there is a strong command for much better performance. To meet these demands, it is indispensable to flatten the screen surface and increase the resolution of the screen. It is also demanded to reduce the weight and thickness of the apparatuses.

As an image display apparatus that satisfies the above demands, attention is now paid to a flat display apparatus, such as a field emission display (hereinafter referred to as an “FED”). FEDs have a first and a second substrate opposing each other with a predetermined space therebetween. The peripheries of these substrates are attached to each other, directly or via a rectangular side wall, thereby constituting a vacuum envelope. Phosphor layers are formed on the inner surface of the first substrate, while a plurality of electron emitting elements as electron sources are provided on the inner surface of the second substrate for exciting the phosphor layer to emit light.

In order to resist the atmospheric pressure load applied to the first and second substrates, a plurality of spacers are arranged as support members between these substrates. To display an image on the FED, an anode voltage is applied to the phosphor layer. An electron beam emitted from the electron-emitting element is accelerated by the anode voltage and collide against the phosphor layer. The phosphor then emits light to display an image.

In the FED constructed as described above, since the size of the electron emitting element is in the order of micrometers, the distance between the first and second substrates can be set to the order of millimeters. Accordingly, compared to, for example, the cathode ray tubes (CRT) used in current televisions or computer displays, resolution enhancement, weight reduction and thickness reduction of image display apparatuses can be realized.

To achieve practical display characteristics of the above-described image display apparatuses, it is desirable to use a phosphor substance similar to the standard cathode ray tubes and to set the anode voltage to several kV or more. However, the space between the first and second substrates cannot be made large in light of resolution, properties of support members, problems raised in manufacture, etc., and must be set to about 1 to 2 mm. Therefore, when electrons emitted from the second substrate collides with a phosphor surface on the first substrate, secondary electrons and reflection electrons generate and collide with the spacers provided between the substrates, with the result that the spacers may well be charged by the electric fields of the electrons. When an acceleration voltage is applied in the FED, the spacers are generally charged positively. At this time, they attract electron beams emitted from electron emitting elements, thereby deviating the electron beams from their correct paths. As a result, mislanding of electron beams on the phosphor layers occurs, thereby degrading the color purity of a display image.

In order to reduce attraction of an electron beam by the spacer, all or part of the spacer surface may undergo a conduction process to remove any unwanted charge. However, when the spacer itself undergoes the conduction process, a reactive current flowing from the first substrate to the second substrate via the spacers increases. This leads to a temperature rise and an increase in power consumption.

### BRIEF SUMMARY OF THE INVENTION

The present invention has been made in consideration of the above situation, and has as its object to provide an image display apparatus which prevents deviation of the track of an electron beam and improves the image quality without any temperature rise and increase in power consumption, and a method of manufacturing the same.

An image display apparatus according to an aspect of the invention comprises a first substrate having an image display surface; a second substrate which faces the first substrate with a gap and has a plurality of electron sources configured to emit electrons to excite the image display surface; a plurality of spacers which are arranged between the first substrate and the second substrate and resist an atmospheric pressure acting on the first substrate and the second substrate; and conductors which are interposed between the second substrate and distal ends of the spacers on the second substrate side, and repulse electron beams emitted from the electron sources

According to another aspect of the present invention, a method of manufacturing an image display apparatus including a first substrate with an image display surface, a second substrate which faces the first substrate with a gap and has a plurality of electron sources configured to emit electrons to excite the image display surface, and a plurality of spacers which are arranged between the first substrate and the second substrate and resist an atmospheric pressure load acting on the first substrate and the second substrate, the method comprises: interposing conductors between predetermined positions on the second substrate and distal ends of the spacers on the second substrate side; and joining the first substrate and the second substrate while arranging the spacers so as to bring the distal ends of the spacers on the second substrate side into contact with the second substrate via the conductors.

### BRIEF DESCRIPTION OF THE SEVERAL VIEWS OF THE DRAWING

FIG. 1 is a perspective view showing an SED according to an embodiment of the present invention;

FIG. 2 is a perspective view showing the SED taken along the line II-II in FIG. 1;

FIG. 3 is an enlarged sectional view showing the SED;

FIG. 4 is an enlarged sectional view showing the main part of an SED according to the second embodiment of the present invention; and

FIG. 5 is an enlarged sectional view showing the main part of an SED according to the third embodiment of the present invention.

### DETAILED DESCRIPTION OF THE INVENTION

An embodiment in which the present invention is applied to a type of FED, i.e., a surface-conduction electron-emitting apparatus (referred to as an SED hereinafter) as a flat image display apparatus will be described in detail with reference to the accompanying drawings.

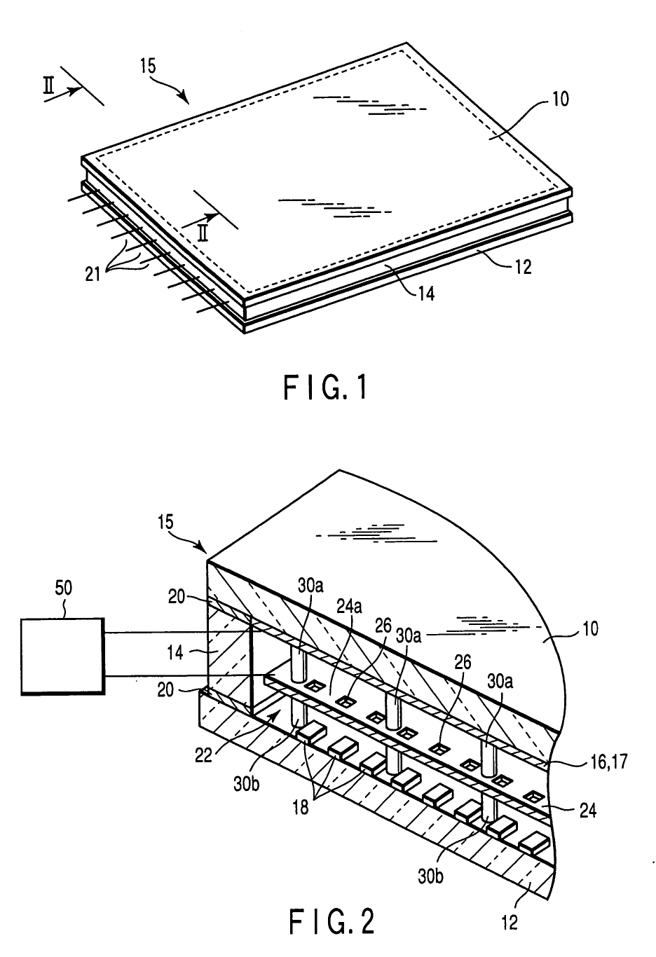

As shown in FIGS. 1 to 3, the SED comprises first and second substrates 10 and 12 formed of rectangular glass plates as transparent insulating substrates. These substrates face each other at a gap of about 1.0 to 2.0 mm. The second substrate 12 is formed at a size slightly larger than the first substrate 10. The first and second substrates 10 and 12 are joined at their peripheral portions via a rectangular glass frame-like sidewall 14, and constitute a flat rectangular vacuum envelope 15.

A phosphor screen 16 serving as an image display surface is formed on the inner surface of the first substrate 10. The phosphor screen 16 is prepared by arraying black light-shielding layers 11 and phosphor layers R, G, and B which emit red, blue, and green light upon collision of electrons. The phosphor layers R, G, and B are formed in stripes or dots. A metal back 17 of aluminum or the like and a getter film (not shown) are formed on the phosphor screen 16. A transparent conductive film of ITO or the like or a color filter film may be interposed between the first substrate 10 and the phosphor screen.

Many surface-conduction electron-emitting elements 18 which emit an electron beam are formed on the inner surface of the second substrate 12 as electron sources for exciting the phosphor layers R, G, B of the phosphor screen 16. The electron-emitting elements 18 are arranged in a plurality of columns or rows in correspondence with pixels. Each electron-emitting element 18 includes an electron-emitting portion (not shown), a pair of element electrodes (not shown) which apply a voltage to the electron-emitting portion, and the like. Many wiring lines 21 which supply a potential to the electron-emitting elements 18 are formed in a matrix on the inner surface of the second substrate 12. The ends of the wiring lines 21 are extracted outside the vacuum envelope 15.

The sidewall 14 functioning as a join member is attached to the peripheral portions of the first and second substrates 10 and 12 with a sealing material 20 such as low-melting-point glass, a low-melting-point metal, or the like. The sidewall 14 joins the first and second substrates with each other.

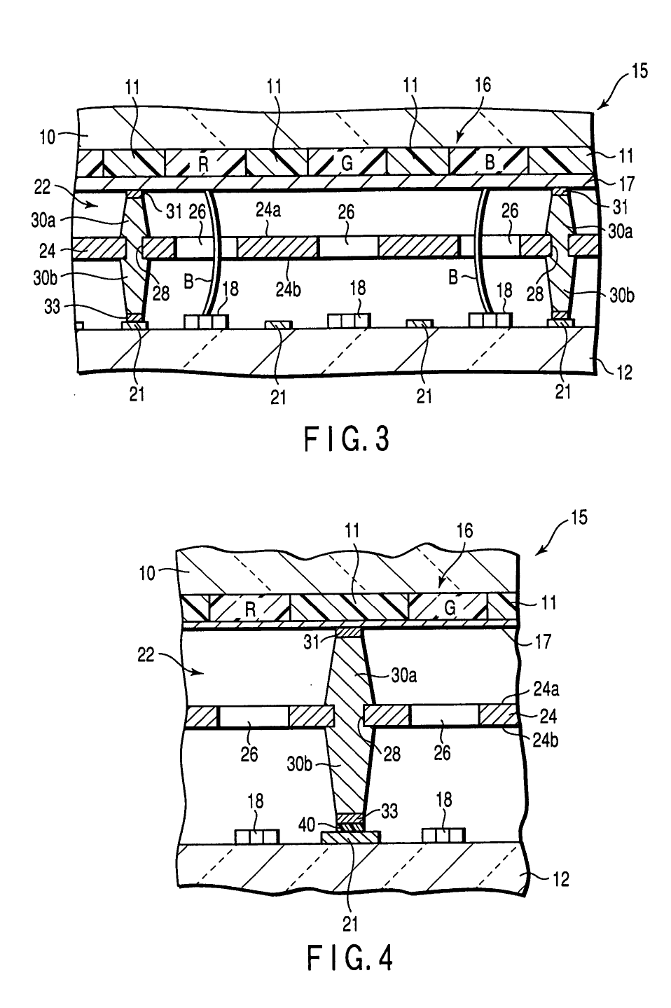

As shown in FIGS. 2 and 3, the SED has a spacer assembly 22 interposed between the first and second substrates 10 and 12. The spacer assembly 22 is formed from a plate-like grid 24, and a plurality of pillar-like spacers which stand integrally on the two surfaces of the grid.

More specifically, the grid 24 has a first surface 24a facing the inner surface of the first substrate 10, and a second surface 24b facing the inner surface of the second substrate 12. The grid 24 is arranged parallel to these substrates. The grid 24 has many electron beam passage apertures 26 and spacer openings 28 which are formed by etching or the like. The electron beam passage apertures 26 functioning as apertures in the present invention are so arrayed as to face corresponding electron-emitting elements 18. The electron beam passage apertures 26 transmit electron beams emitted from the electron-emitting elements. The spacer openings 28 are positioned between the electron beam passage apertures 26, and arrayed at predetermined pitches.

The grid 24 is made of, e.g., an iron-nickel-based metal plate with a thickness of 0.1 to 0.25 mm. The surface of the metal plate is covered with an oxide film of elements forming the metal plate, e.g., an oxide film of Fe₃O₄ or NiFe₃O₄. The surface of the grid 24 is covered with a high-resistance film prepared by applying and baking a high-resistance material such as glass or ceramic. The resistance of the high-resistance film is set to E+8 Ω/□ or more.

The electron beam passage aperture 26 is formed with a rectangular shape of, e.g., 0.15 to 0.25 mm×0.15 to 0.25 mm. The spacer opening 28 is formed with a circular shape whose diameter is, e.g., about 0.2 to 0.5 mm. The high-resistance film described above is also formed on the side surface of the electron beam passage aperture 26 in the grid 24.

First spacers 30a integrally stand on the first surface 24a of the grid 24 at the spacer openings 28. The extending end of each first spacer 30a is coated with an indium layer to form a relaxing layer 31 which relaxes variations in spacer height. The extending end of the first spacer 30a abuts against the inner surface of the first substrate 10 via the relaxing layer 31, the getter film, the metal back 17, and the light-shielding layers 11 of the phosphor screen 16. The relaxing layer 31 is not limited to a metal as far as the material does not influence the track of an electron beam, has an effect of relaxing variations in spacer height, and is hard to a certain degree. The metal back 17 and the black light-shielding layer 11 of the phosphor screen 16 also relax variations in spacer height. When the metal back 17 and black light-shielding layer 11 provide a satisfactory height variation relaxing effect, the relaxing layer 31 need not be formed.

Second spacers 30b integrally stand on the second surface 24b of the grid 24 at the spacer openings 28. The extending ends of the second spacers 30b abut against the inner surface of the second substrate 12. The extending ends of the second spacers 30b are positioned on the wiring lines 21 formed on the inner surface of the second substrate 12. Conductors 33 are interposed between the wiring lines and the extending ends of the second spacers. The conductors 33 are formed with a shape almost similar to the extending end of the second spacer 30b. The thickness of the conductor 33, i.e., the height in a direction perpendicular to the second substrate 12 is set to, e.g., 120 μm.

As will be described later, the conductor 33 acts to repulse an electron beam emitted from the electron-emitting element 18 in a direction to separate from the second spacer 30b. The conductor 33 is formed of a high-melting-point metal, e.g., platinum, tungsten, iridium, rhenium, osmium, or ruthenium, an alloy of these metals, conductive glass containing these metals, or the like. Although a metal such as indium, aluminum, silver, or copper is also available as the conductor 33, a metal having a low melting temperature may melt upon discharge and the original function may fail. Thus, the conductor 33 desirably uses a high-melting-point metal.

The shape of the conductor 33 is not particularly limited, but the corner is desirably rounded in consideration of discharge. The height of the conductor 33 is arbitrarily set in consideration of the repulsive force applied to an electron beam, i.e., the electron beam track correction amount.

Each of the first and second spacers 30a and 30b is tapered narrower toward the distal end so as to decrease the diameter from the grid 24 toward the extending end. For example, the first spacer 30a is formed at a diameter of about 0.4 mm at the proximal end positioned on the grid 24, a diameter of about 0.3 mm at the extending end, and a height of about 0.6 mm. The second spacer 30b is formed at a diameter of about 0.4 mm at the proximal end positioned on the grid 24, a diameter of about 0.25 mm at the extending end, and a height of about 0.8 mm. The height of the first spacer 30a is smaller than that of the second spacer 30b, and the height of the second spacer is set about 4/3 times larger than that of the first spacer.

The first and second spacers 30a and 30b have a surface resistance of 5×10¹³ Ω. The spacer openings 28 and the first and second spacers 30a and 30b are aligned with each other, and the first and second spacers are integrally coupled to each other via the spacer openings 28. The first and second spacers 30a and 30b are formed integrally with the grid 24 while sandwiching the grid 24 from the two surfaces.

The spacer assembly 22 having the above structure is interposed between the first and second substrates 10 and 12. The first and second spacers 30a and 30b abut against the inner surfaces of the first and second substrates 10 and 12, resist the atmospheric pressure load applied to these substrates, and maintain the interval between the substrates at a predetermined value.

As shown in FIG. 2, the SED comprises a voltage application unit 50 which applies a voltage to the grid 24 and the metal back 17 of the first substrate 10. The voltage application unit 50 is connected to the grid 24 and metal back 17, and applies a voltage of 12 kV to the grid 24 and a voltage of 10 kV to the metal back 17. The voltage applied to the grid 24 is set, e.g., 1.25 times or less higher than that applied to the first substrate 10.

To display an image on the SED, an anode voltage is applied to the phosphor screen 16 and metal back 17. An electron beam B emitted from the electron-emitting element 18 is accelerated by the anode voltage and bombarded against the phosphor screen 16. The phosphor layer of the phosphor screen 16 is then excited to emit light and display an image.

A method of manufacturing an SED having the above structure will be explained. In manufacturing the spacer assembly 22, a grid 24 of a predetermined size, and rectangular plate-like first and second molds (not shown) almost equal in size to the grid are prepared. In this case, an Fe-50% Ni thin plate having a plate thickness of 0.12 mm is degreased, cleaned, and dried. Electron beam passage apertures 26 and spacer openings 28 are formed in the thin plate by etching to form a grid 24. The entire grid 24 is oxidized by an oxidization process, and an insulating film is formed on the grid surface including the inner surfaces of the electron beam passage apertures 26 and spacer openings 28. A liquid in which particles of tin oxide and antimony oxide are dispersed is sprayed onto the insulating film, dried, and baked to form a high-resistance film.

The first and second molds have a plurality of through holes corresponding to the spacer openings 28 of the grid 24. In the first and second molds, a resin which thermally decomposes by annealing is applied to at least the inner surfaces of the through holes corresponding to the spacer openings 28.

While the first mold is so positioned as to align the through holes with the spacer openings 28 of the grid 24, the first mold is brought into tight contact with the first surface 24a of the grid. Similarly, while the second mold is so positioned as to align the through holes with the spacer openings 28 of the grid 24, the second mold is brought into tight contact with the second surface 24b of the grid. The first mold, grid 24, and second mold are fixed to each other by using a damper (not shown) or the like.

After that, for example, the paste of a spacer formation material is supplied from the outer surface of the first mold to fill the through holes of the first mold, the spacer openings 28 of the grid 24, and the through holes of the second mold with the spacer formation material. As the spacer formation material, a glass paste containing at least an ultraviolet curing binder (organic component) and glass filler is adopted.

The buried spacer formation material is irradiated with ultraviolet (UV) rays as radiation from the outer surfaces of the first and second molds, UV-curing the spacer formation material. If necessary, thermal curing may be done. The resin applied to the through holes of the first and second molds is thermally decomposed by a heat treatment to form gaps between the spacer formation material and the molds. The first and second molds are removed from the grid 24.

Subsequently, the grid 24 filled with the spacer formation material is heated in a heating furnace to remove the binder from the spacer formation material. The spacer formation material undergoes actual baking at about 500 to 550° C. for 30 min to 1 h. As a result, a spacer assembly 22 having first and second spacers 30a and 30b formed on the grid 24 is obtained.

A first substrate 10 on which a phosphor screen 16 and metal back 17 are formed, and a second substrate 12 on which electron-emitting elements 18 and wiring lines 21 are formed and a sidewall 14 is joined are prepared in advance.

A conductive paste is printed on the wiring lines 21 of the second substrate 12 to have a thickness of 120 μm and a shape almost similar to the distal end of the second spacer 30b. The conductive paste is dried and baked to form conductors 33 at predetermined positions on the wiring lines 21. Indium powder for forming the height-relaxing layer 31 is applied to the extending ends of the first spacers 30a.

The spacer assembly 22 having the above structure is positioned on the second substrate 12. At this time, the spacer assembly 22 is so positioned as to bring the extending ends of the second spacers 30b into contact with the conductors 33. In this state, the first substrate 10, second substrate 12, and spacer assembly 22 are arranged in a vacuum chamber. After the interior of the vacuum chamber is evacuated, the first substrate is joined to the second substrate via the sidewall 14. At the same time, indium powder applied to the extending ends of the first spacers 30a is fused and pressed by the first substrate 10 to correct the height. Accordingly, an SED having the spacer assembly 22 is manufactured.

In the SED having this structure, as shown in FIG. 3, the electron beam B emitted from the electron-emitting element 18 positioned near the second spacer 30b is repulsed by an electric field formed by the conductor layer 33 interposed between the extending end of the second spacer 30b and the second substrate 12. The electron beam B travels toward the electron beam passage aperture 26 while following a track shifted in a direction farther from the second spacer. The electron beam B is then attracted by the charged second and first spacers 30b and 30a, and follows a track shifted in a direction closer to these spacers. Repulsion and attraction cancel deviation of the track of the electron beam B. The electron beam B emitted from the electron-emitting element 18 finally reaches a target phosphor layer of the phosphor screen 16.

More specifically, as the distance from the electron-emitting element to the side surface of the spacer becomes smaller, the moving amount of the electron beam toward the spacer becomes larger. When the distance to the side surface of the spacer is sufficiently large, the moving amount of the electron beam toward the spacer becomes negligible. The electron beam moving phenomenon appears when secondary electrons and reflected electrons generated by the phosphor surface collide against the spacers to charge them. At this time, the secondary electron emission coefficient on the spacer surface becomes 1 or more in accordance with the acceleration voltage used in the SED. The spacer sidewall is positively charged and attracts an electron beam toward the spacer.

In the embodiment, the conductor 33 is interposed between the second substrate and an end of the spacer having a relatively low electron speed on the second substrate side. The conductor 33 forms an electric field in a direction in which the electron beam is repulsed from the spacer. By controlling the height of the conductor 33, the field strength can be changed to control the repulsion amount. In the embodiment, deviation of the track of an electron beam is canceled by attraction to the spacer and repulsion by the conductor 33, instead of removing charge on the spacer. Hence, the SED does not require any complicated mechanism for converging an electron beam, such as the electron gun in the CRT.

In the above-described SED, even when the first and second spacers 30a and 30b are charged and attract the electron beam B, deviation of the track of the electron beam and mislanding of the electron beam B can be prevented. Consequently, degradation of the color purity can be reduced to improve the image quality.

When all or part of the spacer surface directly undergoes a conduction process, a reactive current flowing from the first substrate to the second substrate via the spacer increases, resulting in a temperature rise and an increase in power consumption. A portion having undergone the conduction process functions as a gas generation source during SED operation, and may cause ion bombardment of an electron source positioned near the spacer. To the contrary, the embodiment does not cause any increase in reactive current, temperature rise, increase in power consumption, and ion bombardment. The electric field near the spacer can be changed by the conductor 33 to easily control the track of an electron beam.

An SED according to the embodiment and an SED having no conductor 33 were prepared, and their electron beam moving amounts were compared. In the SED having no conductor, the electron beam moved toward the spacer by about 120 μm. In the SED according to the embodiment, the electron beam moving amount was almost 0, and the color purity of a display image also improved.

In the SED, the grid 24 is interposed between the first and second substrates 10 and 12, and the height of the first spacer 30a is set lower than that of the second spacer 30b. The grid 24 is positioned closer to the first substrate 10 than the second substrate 12. Even if the first substrate 10 discharges, the grid 24 can suppress damage to the electron-emitting element 18 on the second substrate 12 inflicted upon it by discharge. The embodiment can realize an SED which is highly resistant to discharge and exhibits high image quality.

In the SED having the above structure, the height of the first spacer 30a is set lower than that of the second spacer 30b. Even when the voltage applied to the grid 24 is set larger than that applied to the first substrate 10, electrons emitted from the electron-emitting element 18 can reliably reach the phosphor screen.

Even if the first spacers 30a vary in height, the variations can be absorbed by the height-relaxing layer 31, and the first spacers and first substrate 10 can be reliably brought into contact with each other. The first and second spacers 30a and 30b can uniformly hold the interval between the first and second substrates 10 and 12 over almost the entire region.

An SED according to the second embodiment of the present invention will be described. As shown in FIG. 4, according to the second embodiment, a conductor 33 is made of a metal or alloy with a shape similar to the extending end of a second spacer 30b. For example, the conductor 33 is formed from a 200- μm thick metal plate of Fe-50% Ni. The conductor 33 is fixed on a wiring line 21 of a second substrate 12 by a fixing layer 40 made of a conductive frit, conductive adhesive, or the like. A spacer assembly 22 is interposed between a first substrate 10 and the second substrate 12 while the extending end of the second spacer 30b is in contact with the conductor 33.

The remaining structure is the same as that in the first embodiment. The same reference numerals denote the same parts, and detailed description thereof will be omitted.

In manufacturing an SED having the above structure according to the second embodiment, first and second substrates 10 and 12, and a spacer assembly 22 are formed by the same steps as those in the first embodiment. The height of a first spacer 30a was 0.2 mm, and that of a second spacer 30b was 1.0 mm.

Fixing layers 40 are formed by applying a conductive adhesive to predetermined positions on the wiring lines 21 of the second substrate 12 to have a thickness of 5 μm and a shape almost similar to the distal end of the second spacer 30b. Thereafter, 200 - μm thick conductors 33 made of Fe-50% Ni are set on the fixing layers 40. The fixing layers are dried to fix the conductors 33 on the wiring lines.

Similar to the first embodiment, the spacer assembly 22 is positioned on the second substrate 12. At this time, the spacer assembly 22 is so positioned as to bring the extending ends of the second spacers 30b into contact with the conductors 33. In this state, the first substrate 10, second substrate 12, and spacer assembly 22 are arranged in a vacuum chamber. After the interior of the vacuum chamber is evacuated, the first substrate is joined to the second substrate via a sidewall 14, thereby manufacturing an SED.

The SED having the above structure can obtain the same operation effects as those of the first embodiment. In the second embodiment, the fixing layer 40 which fixes the conductor 33 to the wiring line 21 can be utilized as a correction layer for correcting variations in spacer height. Hence, the spacer does not require high processing precision, and the manufacturing cost of the spacer can be reduced.

An SED according to the second embodiment and an SED having no conductor 33 were prepared, and their electron beam moving amounts were compared. In the SED having no conductor, the electron beam was attracted toward the spacer by about 150 μm. In the SED according to the second embodiment, the electron beam moving amount was almost 0, and the color purity of a display image also improved.

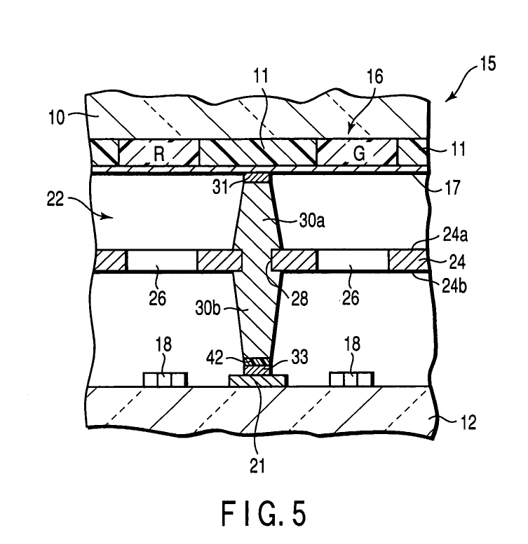

An SED according to the third embodiment of the present invention will be described. As shown in FIG. 5, according to the third embodiment, a conductor 33 is made of a metal or alloy with a shape similar to the extending end of a second spacer 30b. For example, the conductor 33 is formed from a 200 - μm thick metal plate of Fe-50% Ni. The conductor 33 is fixed to the extending end of the second spacer 30b by a fixing layer 42 made of an insulating adhesive, e.g., frit glass. A spacer assembly 22 is interposed between first and second substrates 10 and 12 while the extending end of the second spacer 30b having the conductor 33 fixed to it is in contact with a wiring line 21 on the second substrate 12.

The remaining structure is the same as that in the first embodiment. The same reference numerals denote the same parts, and detailed description thereof will be omitted.

In manufacturing an SED having the above structure according to the third embodiment, first and second substrates 10 and 12, and a spacer assembly 22 are formed by the same steps as those in the first embodiment. The height of a first spacer 30a was 0.2 mm, and that of a second spacer 30b was 1.0 mm.

Fixing layers 42 are formed by applying frit glass to the distal ends of the second spacers 30b of the spacer assembly 22. After 200- μm thick conductors 33 made of Fe-50% Ni are set on the fixing layers 42, the fixing layers are dried to fix the conductors 33 to the distal ends of the second spacers 30b.

The spacer assembly 22 is positioned on the second substrate 12. At this time, the spacer assembly 22 is so positioned as to position, on the wiring lines 21 of the second substrate 12, the extending ends of the second spacers 30b to which the conductors 33 are fixed. In this state, the first substrate 10, second substrate 12, and spacer assembly 22 are arranged in a vacuum chamber. After the interior of the vacuum chamber is evacuated, the first substrate is joined to the second substrate via a sidewall 14, thereby manufacturing an SED.

The SED having the above structure can obtain the same operation effects as those of the first embodiment. In the third embodiment, the fixing layer 42 which fixes the conductor 33 to the distal end of the second spacer can be utilized as a correction layer for correcting variations in spacer height. The spacer does not require high processing precision, and the manufacturing cost of the spacer can be reduced.

An SED according to the third embodiment and an SED having no conductor 33 were prepared, and their electron beam moving amounts were compared. In the SED having no conductor, the electron beam was attracted toward the spacer by about 150 μm. In the SED according to the third embodiment, the electron beam moving amount was almost 0, and the color purity of a display image also improved.

The present invention is not limited to the above-described embodiments, and can be variously modified within the spirit and scope of the invention. For example, the present invention is not limited to an image display apparatus having a grid, and can also be applied to an image display apparatus having no grid. In this case, integrally formed pillar- or plate-like spacers are employed. Conductors are interposed between the second substrate and distal ends of the spacers on the second substrate side. The same operation effects as those described above can be obtained.

In the present invention, the diameter and height of the spacer, the sizes and materials of other building components, and the like can be properly selected. In the above-described embodiments, the conductor is interposed between the wiring line on the second substrate and the distal end of the spacer. The conductor position is not limited to a position on the wiring line. The conductor suffices to be interposed between the second substrate and the distal end of the spacer at a position except the electron-emitting element.

The electron source is not limited to a surface-conduction electron-emitting element, and can also be applied to any type of FED such as a field emission type electron-emitting element or carbon nanotube as far as the FED utilizes an electron source which emits electrons into a vacuum.

1. An image display apparatus comprising:
a first substrate having an image display surface;
a second substrate which faces the first substrate with a gap and has a plurality of electron sources configured to emit electrons to excite the image display surface;
a plurality of spacers which are arranged between the first substrate and the second substrate and resist an atmospheric pressure acting on the first substrate and the second substrate; and
conductors which are interposed between the second substrate and distal ends of the spacers on the second substrate side, and repulse electron beams emitted from the electron sources.

2. The image display apparatus according to claim 1, wherein the conductor is formed by baking a conductive paste.

3. The image display apparatus according to claim 1, wherein the conductor is formed of a metal plate or an alloy plate.

4. The image display apparatus according to claim 3, wherein the conductor is fixed to the second substrate via a conductive fixing layer.

5. The image display apparatus according to claim 3, wherein the conductor is fixed to the distal end of the spacer on the second substrate side via an insulating fixing layer.

6. The image display apparatus according to claim 1, wherein the conductor has a shape similar to the distal end of the spacer on the second substrate side.

7. The image display apparatus according to claim 1, wherein each of the electron sources includes a surface-conduction electron source.

8. The image display apparatus according to claim 1, which further comprises a plurality of wiring lines which are arranged on the second substrate and apply a potential to the electron sources,
the conductors being arranged on the wiring lines.

9. An image display apparatus comprising:
a first substrate having an image display surface;
a second substrate which faces the first substrate at a gap and has a plurality of electron sources configured to emit electrons to excite the image display surface;
a plate-like grid which is arranged between the first substrate and the second substrate and has a plurality of apertures for transmitting electrons emitted from the electron sources;
a plurality of spacers which are fixed to the grid, arranged between the first substrate and the second substrate, and resist an atmospheric pressure acting on the first substrate and the second substrate; and
conductors which are interposed between the second substrate and distal ends of the spacers on the second substrate side, and repulse electron beams emitted from the electron sources.

10. A method of manufacturing an image display apparatus including a first substrate with an image display surface, a second substrate which faces the first substrate with a gap and has a plurality of. electron sources configured to emit electrons to excite the image display surface, and a plurality of spacers which are arranged between the first substrate and the second substrate and resist an atmospheric pressure load acting on the first substrate and the second substrate, the method comprising:
interposing conductors between predetermined positions on the second substrate and distal ends of the spacers on the second substrate side; and
joining the first substrate and the second substrate while arranging the spacers so as to bring the distal ends of the spacers on the second substrate side into contact with the second substrate via the conductors.

11. The method of manufacturing an image display apparatus according to claim 10, wherein the interposing the conductors includes painting a conductive paste at desired positions on the second substrate with a shape substantially similar to a shape of the distal end of the spacer, and baking the conductive paste to form the conductors.

12. The method of manufacturing an image display apparatus according to claim 10, wherein the interposing the conductors includes forming conductive fixing layers at desired positions on the second substrate, and setting and fixing conductors which are formed of a metal or an alloy plate and have a shape substantially similar to a shape of the distal end of the spacer on the fixing layers.

13. The method of manufacturing an image display apparatus according to claim 10, wherein the interposing the conductors includes forming insulating fixing layers on the distal ends of the spacer on the second substrate side, and fixing conductors which are formed of a metal or an alloy plate and have a shape substantially similar to a shape of the distal end of the spacer to the distal ends of the spacers via the fixing layers.
